(19) United States
(12) Patent Application Publication
(10) Pub. No.: US 2021/0109917 A1
(43) Pub. Date: Apr. 15, 2021

(54) System and Method for Processing a Database Query

(71) Applicant: THE HONG KONG POLYTECHNIC UNIVERSITY, Hong Kong (CN)

(72) Inventors: Bin Xiao, Hong Kong (CN); Yu Zhou, Hong Kong (CN)

(21) Appl. No.: 16/597,903

(22) Filed: Oct. 10, 2019

(51) Int. Cl. G06F 16/23; G06F 21/60; G06F 21/62; G06F 16/27; G06F 16/245; G06F 16/22

(52) U.S. Cl. CPC G06F 16/2379; G06F 21/602; G06F 21/6227; G06F 16/2255; G06F 16/245; G06F 16/2246; G06F 16/27

(57) ABSTRACT

A system and a method for processing a database query are provided. The system includes a server associated with one or more databases and a cryptographic structure storing one or more fingerprints in a plurality of nodes, each of the one or more fingerprints associated with a respective database of the one or more databases. The server includes at least one processor, and at least one memory including computer program code. The at least one memory and the computer program code are configured to, with the at least one processor, cause the server at least to receive an input requesting a database query result to the database query, determine the database query result based on the one or more databases in response to the input, and determine one or more fingerprints of the databases associated with the database query result, and a verifying value in response to the determined one or more fingerprints, the verifying value being one that is used to verify if the determined one or more fingerprints are part of the cryptographic structure.

### TECHNICAL FIELD

The present invention generally relates to a system and method for processing a database query.

### BACKGROUND ART

Blockchain technology, first implemented in managing Bitcoin and subsequently in other cryptocurrencies, has triggered a wave of innovation in decentralised computing. Blockchain technology, also known as distributed ledger technology, uses a distributed, decentralized, shared and replicated ledger to protect data cryptographically stored as blocks on the ledger. The data on the ledger is considered immutable as each block on a blockchain incorporates the hash function of a preceding block. Consequently, it would be computationally impractical to modify data stored on a block, because to do so would require every block after it to be regenerated. Blockchain technology, first used to facilitate payment transactions, has a wide range of applications, and have been since implemented in smart contracts, supply chain management, healthcare, distributed storage and Internet of Things (IoT). Blockchain-based applications can potentially lower operating costs, increase tamper resistance of data, reduce fraud and enhance contract execution, while ensuring that the data is immutable.

While adoption of blockchain technology is increasing, most existing implementations support only a limited query service, which provides query results in response to a search query directed to the information stored on the blockchain. Blockchain technology is traditionally concerned with information storage in a distributed, immutable database. To query a record in the database, a system typically requires all participants (i.e. peer nodes which store the distributed ledger) to traverse all records stored on the blockchain to generate a query result. Hence, the query process can be extremely time-consuming. Thus, while the distributed nature of blockchain technology can ensure that existing records are practically immutable, challenges on how to efficiently search records stored on a blockchain while verifying the authenticity of the results remain.

One approach used to address the query efficiency problem involves maintaining some limited states (e.g. the balance of each address (account) in the distributed ledger system) on each peer node. For example, peer nodes in a Bitcoin system can preserve the current balance of each address as the current state, and can respond to balance queries quickly without having to search the records on the blockchain. Preserving the current state can also allow the peer nodes (e.g. the miners) to verify each transaction more efficiently. However, the approach is impractical for multi-state queries, as all queried states must be predefined and stored in the peer nodes. For example, the existing Bitcoin system, which preserves the current balance of each address as the current state, supports only efficient query of the address balance. If another state (e.g. time of transactions of an account, transaction amount) is queried, peer nodes would have to resort to direct query, i.e. to traverse each block in the blockchain for the query result. The peer nodes, each storing a complete balance list in this implementation, would also have to collect responses from several other peer nodes to validate the result. Thus, the approach is not efficient, as peer nodes incur significant storage and communication costs.

Another approach used to address the query efficiency problem involves querying a distributed database storing data recorded on the blockchain, instead of querying the blockchain itself. The distributed database can share features similar to those of a traditional distributed database, including low latency and support for multi-state queries. However, the approach would require users to trust the query results provided by the distributed database, and to trust that the data stored on the distributed databases are identical to that of the blockchain, since the distributed database cannot prove that the data stored thereon are identical to that stored on the blockchain.

Accordingly, what is needed is a system and method for processing a database query that seeks to address some of the above problems. Furthermore, other desirable features and characteristics will become apparent from the subsequent detailed description and the appended claims, taken in conjunction with the accompanying drawings and this background of the disclosure.

### SUMMARY OF INVENTION

An aspect provides a server for processing a database query, the server associated with one or more databases and a cryptographic structure, the cryptographic structure storing one or more fingerprints in a plurality of nodes, each of the one or more fingerprints associated with a respective database of the one or more databases, the server including:

at least one processor; and

at least one memory including computer program code;

the at least one memory and the computer program code configured to, with the at least one processor, cause the server at least to:

receive an input requesting a database query result to the database query;

determine the database query result based on the one or more databases in response to the input; and

determine one or more fingerprints of the databases associated with the database query result, and a verifying value in response to the determined one or more fingerprints, the verifying value being one that is used to verify if the determined one or more fingerprints are part of the cryptographic structure.

The server may be further configured to construct the one or more databases based on information stored on a distributed ledger, and generate the one or more fingerprints, each of the one or more fingerprints associated with a respective database of the one or more databases.

The server may be configured to generate each fingerprint based on a hash of the data stored on the respective database and a metadata value of the respective database.

The server may be configured to further transmit the one or more fingerprints to a verification server, the verification server being configured to store the one or more fingerprints on the distributed ledger.

The server may be further configured to receive, from a verification server, the cryptographic structure storing the one or more fingerprints associated with the one or more databases in the plurality of nodes.

The server may be configured to identify one or more nodes within the cryptographic structure associated with each of the determined one or more fingerprints, and generate at least one verifying value associated with the one or more identified nodes, the at least one verifying value used to verify if the determined one or more fingerprints are part of the cryptographic structure.

The cryptographic structure may include a Merkle-Patricia Tree, and the server may be configured to identify one or more nodes within the cryptographic structure that forms a path from a top node to a base node, the top node associated with a first character and the base node associated with a last character of a fingerprint in the one or more fingerprints.

The server may be configured to generate verifying values of one or more sibling nodes of the one or more identified nodes within the cryptographic structure.

The plurality of nodes in the Merkle-Patricia tree may include one or more of a key/value pair or a branch node. The key in the key/value pair is associated with a character of a corresponding fingerprint in the one or more fingerprints and the value in the key/value pair is associated with a location of the distributed ledger where the corresponding fingerprint is stored.

Another aspect provides a method for processing a database query at a server, the server associated with one or more databases and a cryptographic structure, the cryptographic structure storing one or more fingerprints in a plurality of nodes, each of the one or more fingerprints associated with a respective database of the one or more databases, the method including:

receiving, at the server, an input requesting a database query result to the database query;

determining, at the server, the database query result based on the one or more databases in response to the input; and

determining, at the server, one or more fingerprints of the databases associated with the database query result, and a verifying value in response to the determined one or more fingerprints, the verifying value being one that is used to verify if the determined one or more fingerprints are part of the cryptographic structure.

The method may further include constructing, at the server, the one or more databases based on information stored on a distributed ledger, and generating, at the server, the one or more fingerprints, each of the one or more fingerprints associated with a respective database of the one or more databases.

The step of generating the one or more fingerprints may include generating, at the server, each fingerprint based on a hash of the data stored on the respective database and a metadata value of the respective database.

The method may further include transmitting the one or more fingerprints to a verification server, the verification server being configured to store the one or more fingerprints on the distributed ledger.

The method may further include receiving, from a verification server, the cryptographic structure storing the one or more fingerprints associated with the one or more databases in the plurality of nodes.

The step of determining, at the server, the verifying value used to verify if the determined one or more fingerprints are part of the cryptographic structure may include identifying, at the server, one or more nodes within the cryptographic structure associated with each of the determined one or more fingerprints, and generating, at the server, at least one verifying value associated with the one or more identified nodes, the at least one verifying value used to verify if the determined one or more fingerprints are part of the cryptographic structure.

The cryptographic structure may include a Merkle-Patricia Tree, and the step of identifying the one or more nodes within the cryptographic structure associated with each of the determined one or more fingerprints may include identifying, at the server, one or more nodes within the cryptographic structure that forms a path from a top node to a base node, the top node associated with a first character and the base node associated with a last character of a fingerprint in the one or more fingerprints.

The step of generating, at the server, at least one verifying value associated with the one or more identified nodes may include generating verifying values of one or more sibling nodes of the one or more identified nodes within the cryptographic structure.

The plurality of nodes in the Merkle-Patricia tree may include one or more of a key/value pair or a branch node. The key in the key/value pair is associated with a character of a corresponding fingerprint in the one or more fingerprints and the value in the key/value pair is associated with a location of the distributed ledger where the corresponding fingerprint is stored.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a schematic diagram of a server for processing a database query, in accordance with embodiments of the invention.

FIG. 2 shows a schematic diagram of a system including the server of FIG. 1, in accordance with embodiments of the invention.

FIG. 3 shows a schematic diagram of database, in accordance with an embodiment of the invention.

FIG. 4 shows a schematic diagram of database, in accordance with another embodiment of the invention.

FIG. 5 shows a flowchart illustrating a method of processing a database query, in accordance with embodiments of the invention.

FIG. 6 shows a schematic diagram of a verification process, in accordance with embodiments of the invention.

FIG. 7 shows a schematic diagram of a cryptographic structure, in accordance with embodiments of the invention.

FIG. 8 shows a comparison of query throughput between an exemplary implementation of the present invention against a traditional approach involving direct query of a distributed ledger.

FIG. 9 shows a comparison of block query time between the exemplary implementation of the invention and the traditional approach.

FIG. 10 shows a comparison of transaction query time between the exemplary implementation of the invention and the traditional approach.

FIG. 11 shows a comparison of account query time between the exemplary implementation of the invention and the traditional approach.

FIG. 12 shows a comparison of range query time between the exemplary implementation of the invention and the traditional approach.

FIG. 13 shows a comparison of database verification times for key and micro databases constructed from distributed ledgers with blocks of between 1 million to 19 million, in accordance with embodiments of the invention.

FIG. 14 shows a comparison of database sizes for key and micro databases constructed from distributed ledgers with blocks of between 1 million to 19 million, in accordance with embodiments of the invention.

FIG. 15 shows a comparison of proof cost (proof size) for fingerprints with depth of between 7 to 13, in accordance with embodiments of the invention.

FIG. 16 shows a comparison of storage size of cryptographic structures with between 1000 to 190,000 fingerprints, in accordance with embodiments of the invention.

FIG. 17 shows a comparison of throughput and proof size of an exemplary implementation of the present invention, with between 1900 to 19000 fingerprints, in accordance with embodiments of the invention.

FIG. 18 shows fingerprint depth distributions of an exemplary implementation of the present invention, with 1,000, 20,000 and 190,000 fingerprints, in accordance with embodiments of the invention.

FIG. 19 shows a schematic diagram of a computing device used to realise the system of FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

### Preliminary Concepts

Concepts related to the present invention is briefly described in this section.

Blockchain: Blockchain is a distributed ledger that can be used to record transactions in a decentralized network. A typical blockchain (i.e. a distributed ledger) usually comprises a series of blocks that are cryptographically chained in order, by including a hash function of the preceding block. A block mainly consists of a block header storing the attributes of the block (e.g. timestamp and the hash value of the preceding block), and a block body, which contains the corresponding list of transactions details in the block. In the blockchain network, each full node can maintain a copy of the distributed ledger. It can be appreciated that the consistency of the ledger can be guaranteed by adopting various consensus algorithms such as Proof of Work, Proof of Stake and Practical Byzantine Fault Tolerance (PBFT). Blockchain is firstly introduced for consensus (agreement on some data value that is needed during computation) in Byzantine failures (a condition of a computer system, particularly distributed computing systems, where components may fail and there is imperfect information on whether a component has failed). The first implementation of a blockchain-based application is the Bitcoin system. By maintaining a distributed ledger known as the blockchain, the Bitcoin system creates a decentralized, open and Byzantine fault-tolerant transaction paradigm, which conforms to the requirements of a cryptocurrency network infrastructure. Specifically, each block in a blockchain consists of two parts: header and records. Header contains the information of the block, including a Merkle root (i.e. hash of all hashes of recorded transactions), a hash value of the previous block header, a cryptographic nonce (an arbitrary number that can be used just once in a cryptographic communication), etc. Data (i.e. transactions in the Bitcoin system) are stored in the blockchain as records. Blocks are chained together by headers using a cryptographic hash as a means of reference. A blockchain network typically include the following features:

Transparency: Transparency is used in the description below to describe that the records, typically stored in a distributed ledger network, are accessible by all participants to the blockchain. For example, a participant can obtain the current state of the blockchain system based on the records in the blockchain.

Consensus: Consensus is used in the description below to describe a state in which peer nodes (i.e. participants) can arrive at on a blockchain without unintentional forks. By having reached consensus, it may mean that a valid block generated by a peer can be recorded on the blockchain and accepted by other peers.

Verifiability: Verifiability is used in the description below to describe that participants to the blockchain can validate the current state based on the records in the blockchain.

Merkle Patricia Tree: The Merkle Patricia Tree (MPT) is first introduced in Ethereum (a blockchain-based application). MPT is a cryptographically authenticated data structure (i.e. cryptographic structure) combining the Trie tree and the Merkle tree. MPT can be used to store [key,value] bindings and there are three kinds of nodes provided in an MPT, i.e., Leaf Nodes (LN), Branch Nodes (BN) and Extension Nodes (EN). A leaf node represents [key,value] pair, where key is the public prefix and value is the terminal value at the node. An extension node also represents [key,value] pair, but the value of the extension node is the hash of the next node. The branch node is a 17-element array node and used to store viable leaf nodes or extension nodes when the prefixes of keys differ. Among the 17 elements, the first 16 elements are the hex characters, representing possible prefix of the next node. The last element is used to store the final target value if the path has been fully traversed. In MPT, each node is denoted by its hash that encoded in Recursive Length Prefix (RLP) code, which is designed to encode arbitrarily nested arrays of binary data. It is noted that the MPT is fully deterministic, which means given the same (key,value) bindings, the MPT constructed from them is guaranteed to be exactly the same regardless of their insertion order and thus have the same root hash. MPT provides O(log(n)) efficiency for inserts, deletes and searches, in contrast to node insertion and deletion in Merkle Tree, which incur huge time cost. Moreover, with a publicly known root hash, it can be proven that there exists a given value at a specific path in the MPT by providing the nodes along the way.

In an embodiment of the invention, the Merkle Patricia Tree (also known as a cryptographic structure) stores one or more fingerprints in a plurality of nodes, each of the one or more fingerprints associated with a database constructed based on information stored on a distributed ledger. Each of the one or more fingerprints is also stored on the distributed ledger (also known as a blockchain), and location information of the distributed ledger where the corresponding fingerprint is stored (also known as a height or value) is included in the Merkle Patricia Tree. Specifically, leaf nodes in the Merkle Patricia Tree can include a key/value pair and the value in the key/value pair is associated with the location of the distributed ledger where the corresponding fingerprint is stored. The key in the key value pair is associated with a character of a corresponding fingerprint in the one or more fingerprints, such that a path from root of the Merkle Patricia Tree to the leaf node forms a character string of the fingerprint. In other words, the Merkle Patricia Tree stores height of the [fingerprint, height] pair in the leaf node and, the path from the root to the leaf node stores fingerprint of the [fingerprint, height] pair.

### General Overview

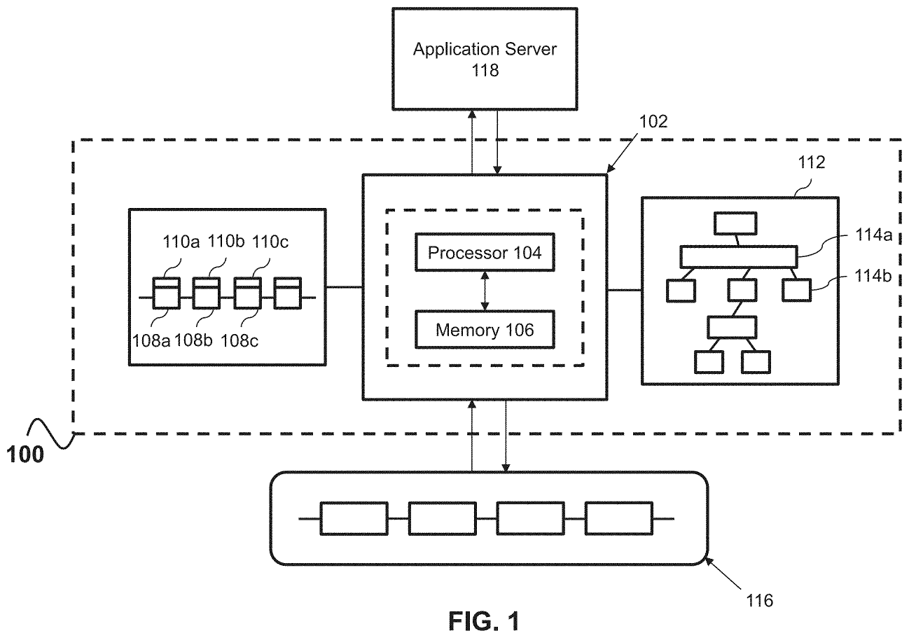

Embodiments of the present invention seek to provide a system and method of processing a database query. In various embodiments, the database query can include a blockchain query (i.e. a request to retrieve information associated with, or stored on the blockchain). An example of the system is system 100 shown in FIG. 1. The system 100 comprises a server 102 for processing the database query. The server comprises at least one processor 104 and at least one memory 106 including computer program code. The server is communicatively coupled with one or more databases 108a, 108b, 108c and a cryptographic structure 112, the cryptographic structure 112 storing one or more fingerprints 110a, 110b, 110c in a plurality of nodes 114a, 114b, each of the one or more fingerprints 110a, 110b, 110c associated with a respective database of the one or more databases 108a, 108b, 108c. The cryptographic structure 112 can be a Merkle Patricia Tree described in the preceding paragraphs. The at least one memory 106 and the computer program code is configured to, with the at least one processor 104, cause the server 102 at least to receive an input requesting a database query result to the database query, determine the database query result based on the one or more databases 108a, 108b, 108c in response to the input and determine one or more fingerprints of the databases associated with the database query result, and a verifying value in response to the determined one or more fingerprints, the verifying value being one that is used to verify if the determined one or more fingerprints are part of the cryptographic structure 112.

The server 102 can be configured to construct the one or more databases 108a, 108b, 108c based on information stored on a distributed ledger 116 and generate the one or more fingerprints 110a, 110b, 110c, each of the one or more fingerprints 110a, 110b, 110c associated with a respective database of the one or more databases 108a, 108b, 108c. Each fingerprint 110a, 110b, 110c can be generated based on a hash of the data stored on the respective database 108a, 108b, 108c and a metadata value of the respective database 108a, 108b, 108c.

In embodiments of the present invention, the system 100 can be referred as a Verifiable Query Layer (VQL). VQL can be a middleware layer deployed in datacentres to provides query services and query results for blockchain-based systems. A query service system including the VQL can have a three-layer architecture, and includes the distributed ledger 116 (also referred to as the underlying blockchain system), the system 100, and an application server 118. The system 100 can extract transactions stored in the distributed ledger 116 and reorganise the information in the one or more databases 108a, 108b, 108c to provide various query services to the application server 118. A cryptographic hash value is calculated for each constructed database 108a, 108b, 108c to ensure authenticity of query result. The database fingerprints 110a, 110b, 110c, including the respective hash value and some properties of respective database (i.e. metadata values such as name, size and time stamp, etc.), can verified by verification servers (also referred to as miners or peer nodes) and further stored in the distributed ledger. The database verification scheme can prevent the server (i.e. middleware layer) from storing any false data in the databases. Users who access the query services can also download the information available on the distributed ledger to verify the databases if they do not trust the server 102.

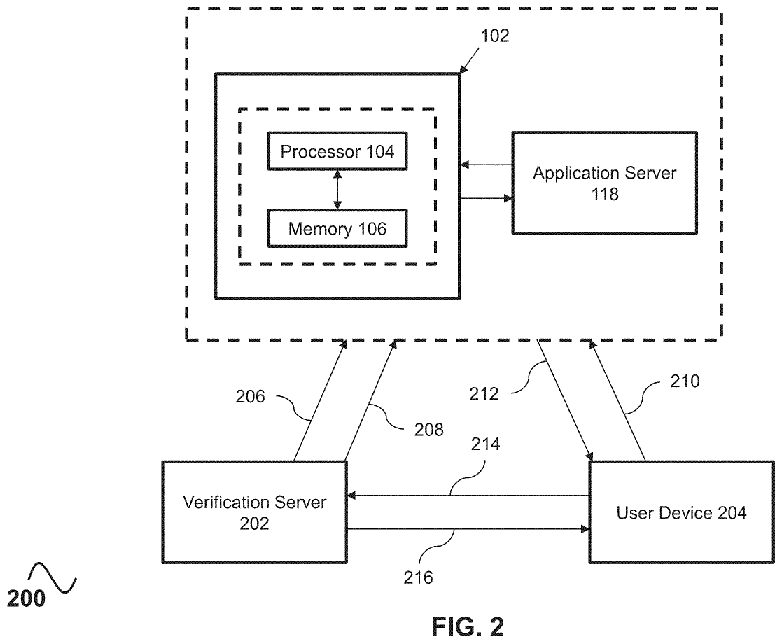

A simplified query result verification scheme is also disclosed. A system implementing the simplified query result verification scheme is shown in FIG. 2 and the system can allow users to check the validity of databases that their query involves. In embodiments of the present invention, the system may be applied to Ethereum-based applications and systems (a specific implementation of a distributed ledger). It can be appreciated that the system can also be applied to other blockchain systems as VQL can be built on any given blockchain. Advantageously, embodiments of the present invention can provide efficient and authentic querying services, and can (1) support query services with high efficiency for different data analysis tasks based on a distributed ledger, (2) ensure data consistency between the constructed databases in the VQL and the underlying distributed ledger, (3) improve storage space efficiency in the VQL and (4) verify the integrity of the databases upon which the users' query results are based efficiently.

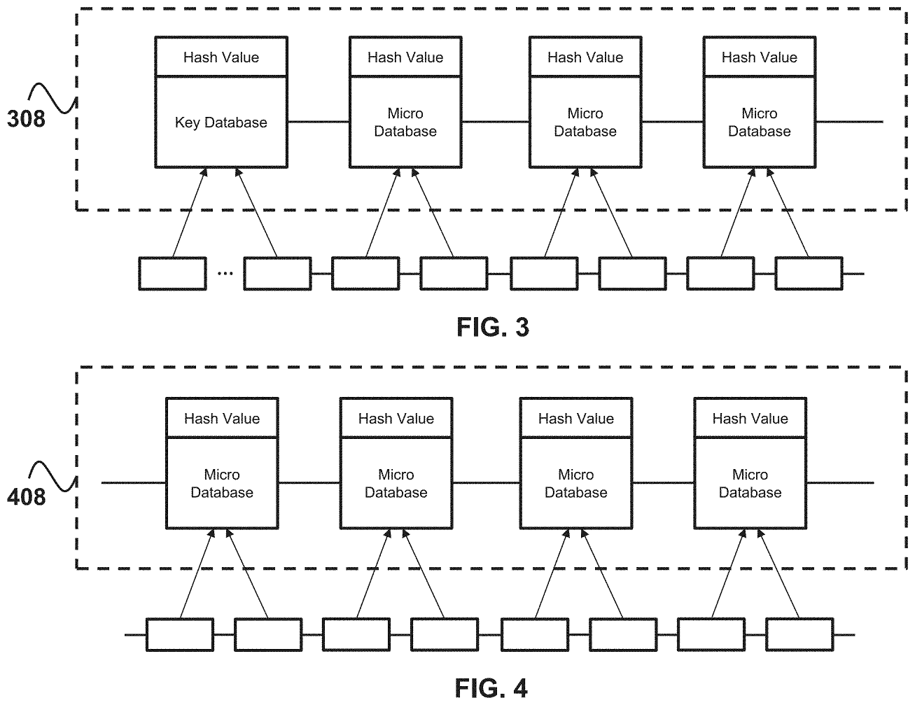

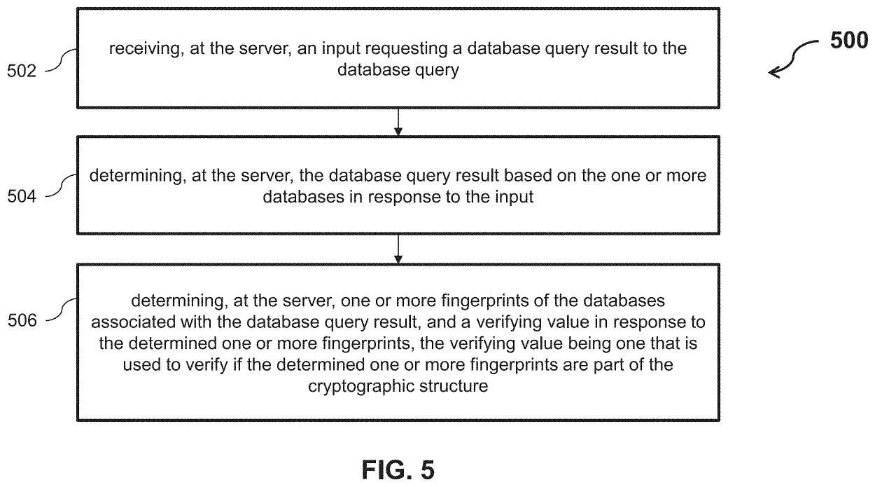

In embodiments of the invention, a query service system including the VQL has a three-layer architecture, which can efficiently support various query services, e.g., from account query to complicated range query, without resorting to browsing each block in the distributed ledger. Databases can be dynamically constructed and updated by the VQL to provide various query services. In an embodiment of the invention, the constructed databases can comprise a key database and one or more micro databases (see FIG. 3). In an alternative embodiment, the constructed databases comprises one or more micro databases, but does not include a key database (see FIG. 4). A verification service, based on the constructed database to ensure its consistency with the underlying distributed ledger is also provided. The fingerprints of databases are recorded and stored as a transaction in the blockchain by the verification servers (e.g. miners or peer nodes). Miners or users with blockchain data can verify the correctness of a database using these fingerprints.

An alternate query result verification scheme for users to verify the received result is also disclosed. In the alternate query result verification scheme, users need not download the entire database. In the alternate query result verification scheme, users can query several involved databases and validate their fingerprints efficiently. An exemplary implementation of the present invention along with the different verification schemes are also disclosed. Evaluations based on Ethereum and MongoDB (a database program) are conducted and the results are discussed below. The results illustrate that VQL can efficiently support various query and verification services while guaranteeing data authenticity.

The following is organised as follows. A description of the system is provided under System Overview, followed with the details of the system design. An exemplary system implementation is then disclosed, followed by performance evaluation of the system.

### System Overview

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “associating”, “calculating”, “comparing”, “determining”, “forwarding”, “generating”, “identifying”, “including”, “inserting”, “modifying”, “receiving”, “replacing”, “scanning”, “transmitting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

Such a server may be server 102 as shown in FIG. 1. FIG. 1 shows a schematic diagram of a server 102 for processing a database query, in accordance with embodiments of the invention. The server 102 is communicatively coupled with distributed ledger 116 and application server 118. The server 102 can support data query and analysis through reorganisation of the distributed ledger 116, and the application server 118 can provide various communication services to end users (not shown). The server 102, distributed ledger 116 and the application server 118 form a three-layer architecture system. The server 102 is also known as a Verifiable Query Layer (VQL), and can be a middleware layer deployed in datacentres to provides query services and query results for blockchain-based systems.

### Distributed Ledger 116

In various embodiments of the present invention, transactions generated from users are stored in the blocks and form a distributed ledger in a blockchain system. Some distributed ledger platforms (blockchain platforms) such as Ethereum provide an application programming interface (API) to access the transactions stored in each block. Hence, an API provided, for example by Ethereum, can be used by server 102 to extract blocks and transaction information stored in the Ethereum blockchain. A similar approach can also be applied to other blockchain systems, e.g. those implemented on logistics and supply chain, which record the information of goods delivery and market transaction using a consortium blockchain.

### Server 102

After obtaining block and transaction information from the underlying distributed ledger 116, the server 102 re-organizes the information into the one or more databases 108a, 108b, 108c to provide various query services for the application server 118. In an embodiment, as shown in FIG. 3, in order to support efficient data query, the server 102 can construct a database 308 comprising a key database and one or more micro databases. In another embodiment, as shown in FIG. 4, the server 102 can construct a database 408 comprising one or more micro databases, but does not include a key database. With more blocks generated in the blockchain, the server 102 will dynamically update the constructed databases to timely store new data. Further, in order to verify the authenticity of query results with the underlying blockchain (i.e., data authenticity), a database verification scheme to prevent falsified data being stored in the server 102 is provided. To verify the constructed databases, a cryptographic hash value is calculated by the server for each constructed database. The cryptographic hash value can be a hash of the data stored on the respective database. A database fingerprint 110a, 110b, 110c is also generated, based on the cryptographic hash value and some metadata value of the respective database (i.e., database properties such as name, size and time stamp of the database). The database fingerprint can be verified by verification servers and then stored in the blockchain. Thus, the middleware layer can provide efficient and verifiable query services to ensure the query result authenticity for the blockchain system.

### Application Server 118

The server 102 can provide various data query services for the application server 118 after the databases 108a, 108b, 108c are constructed. The application server 118 can provide for various data analysis and machine learning tasks based on the databases 108a, 108b, 108c. Besides providing query services for normal users and data platforms, the application server 118 can also support public audit (verification) services performed by audit institutions such as verification server 202, which validates the authenticity of the information stored on the server 102. The auditors are able to audit the information in the distributed ledger 116 using the fingerprints 110a, 110b, 110c provided by the server 102.

### Details of System Design

The system 100, also referred to as Verifiable Query Layer (VQL), which supports efficient data query for various blockchain-based applications is first described. Verification schemes of data query, which verifies the authenticity of query results with the distributed ledger, is then presented.

### VQL Design for Blockchain-Based Applications

Structure of the VQL. Given a blockchain storing many transactions, the server 102 extracts all transactions and constructs one or more databases 108a, 108b, 108c to support efficient data query and data analysis. FIG. 3 shows an example of the one or more databases 300 in accordance with an embodiment of the present invention. The one or more databases 300 including two types of databases: key database and micro database, and their hash values. The key database contains all transactions generated and stored in the blockchain until a specified point in the timeline (e.g., the end of a month). The micro database contains the transactions generated in each time interval (e.g., in every day) after the specified time point. It can be appreciated that the values of the specified time point and the time interval, i.e., end of a month and every day provided above are exemplary and that the values of the specified time point and the time interval can be adjusted for different scenarios. Each database has a header that contains a cryptographic hash value (i.e. a fingerprint) generated based on a hash of the data stored on the database and a metadata value of the database. The hash value of database can be utilized to verify the data integrity of the database.

In an alternative embodiment, the one or more databases excludes the key database. FIG. 4 shows one or more databases 400 including a single type database (micro database) and their hash values. The micro database contains the transactions generated in each time interval (e.g., on a daily basis) after the specified time point. In other words, a key database which includes all transactions generated and stored in the blockchain until a specified point in the timeline is not generated in the alternative embodiment. It can be appreciated that each micro database can be configured to store only multiple states, or a particular state (e.g. a block, transaction, time or transaction location).

Database update Algorithm 1a presented below shows an exemplary method of managing the one or more databases 300 described above in paragraph [0072]. Specifically, Algorithm 1a shows an exemplary method of merging micro databases into the key database and an exemplary method of generating new micro databases from newly generated blocks in the distributed ledger. The server 102 can be configured to execute Algorithm 1a to merge constructed micro databases into the key database and to generate new micro databases from newly generated blocks in the distributed ledger at a specific frequency. As new transactions and blocks are usually generated continuously in a distributed ledger, Algorithm 1a can be configured to generate micro databases to support query services for the application layer in a timely manner. The key database is updated at a relatively lower frequency (e.g., on a monthly basis) to reduce the computation cost. At the end of every month, the micro databases generated in the month will be merged into the key database. A new hash value (fingerprint) will be calculated for the updated key database. The micro databases and their hash values will then be deleted from the server to improve the storage space efficiency in the server. Similarly, new micro databases will be generated at a specific frequency (e.g. on a daily basis) in the subsequent month, and merged into the key database at the end of the month as before. With the updated database, the application server can query all historical data from the key database or query data generated in each day of the current month from the corresponding micro database. Accordingly, as new blocks are generated on the blockchain, the server will be updated in time, and can support up-to-date query services.

Algorithm 1a

```
Require:
  BLK: Block in the blockchain;
  D: Day
Ensure: kDB: Key database; mDB: Micro database
1: for each day do
2:  if D = End of Month then
3:  Construct a new mDB from BLKs;
4:  HASH(mDB);
5:  Merge all mDBs into kDB;
6:  HASH(kDB);
7:  Delete all mDBs;
8: else
9:  Construct a new mDB from BLKs;
10:  HASH(mDB);
11: end if
12: end for
13: return kDB and mDBs;
```

### Algorithm 1a: Middleware Update

Database update Algorithm 1b presented below shows an exemplary method of managing the one or more databases 400 described above in paragraph [0073]. Specifically, Algorithm 1b shows an exemplary method of generating new micro databases from newly generated blocks in the distributed ledger. The server 102 can be configured to execute Algorithm 1b to generate new micro databases from newly generated blocks in the distributed ledger at a specific frequency. As transactions occur, new blocks are generated in a distributed ledger, and Algorithm 1b can be configured to generate micro databases to support query services for the application layer in a timely manner. The micro databases can be generated at a specific frequency (e.g. on a daily basis) with Algorithm 1b. With the updated database, the application server can query data generated in each day from the corresponding micro database. Accordingly, as new blocks are generated on the blockchain, the database can be updated in time, and up-to-date query services can be supported.

Algorithm 1b

```
Require:
  BLK: Block in the blockchain;
  D: Day
Ensure: mDB: Micro database
1: for each day do
2:  Construct a new mDB from BLKs;
3:  HASH(mDB);
4: end for
5: return mDBs ;
```

### Algorithm 1b: Middleware Update

### Database Verification Scheme

Database verification schemes are now described. The verification scheme, which can be carried out by verification servers (e.g. miners and/or peer nodes) and end-users, can ensure that the information stored on the databases is consistent with the underlying blockchain (i.e. the authenticity of the generated databases can be verified).

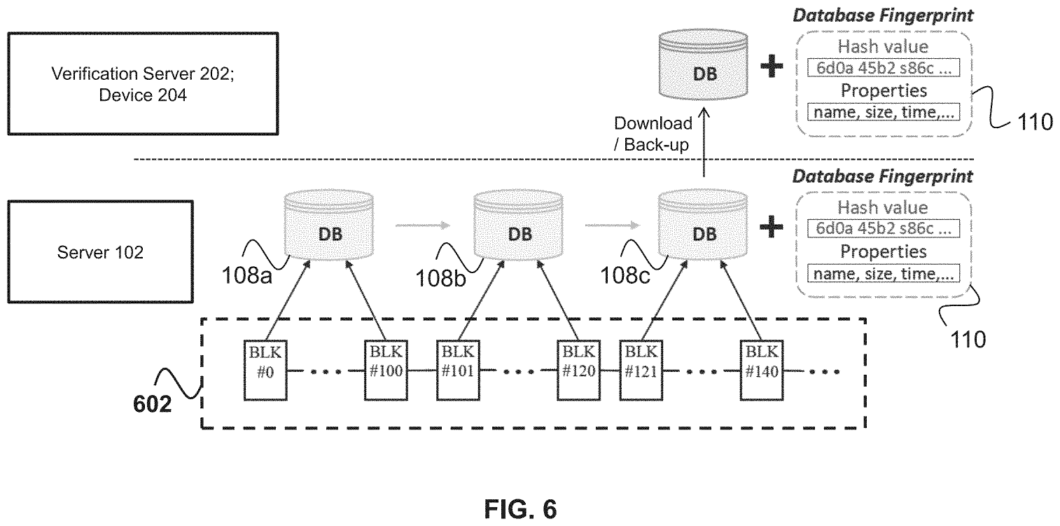

Miner verification scheme. FIG. 6 illustrates the verification process of the databases. As shown in FIG. 6, various transactions generated by users are stored in the blockchain 602 by the miners. Information associated with the transactions are extracted from the blockchain 602 and reorganised into the databases 108a, 108b, 108c by the server 102 to provide query services. To prevent falsified data from being stored in the databases 108a, 108b, 108c, a unique fingerprint is generated for each constructed database, each fingerprint generated based on a hash of the data stored on the respective database and a metadata value of the respective database. The constructed fingerprint of each databases 108a, 108b, 108c can verified by miners and then stored in the underlying blockchain 602.

User verification scheme. A public verification scheme can be used by users to verify that the data recorded in the databases 108a, 108b, 108c is consistent with the blockchain 602. The server 102 can be accessed by the users through device 204, which can communicate with the application server 118 for data query via. Users can usually trust the query results returned from by the server 102 since the databases 108a, 108b, 108c stored therein have already been verified by miners. In the event that users have questions about the databases 108a, 108b, 108c, the users can download data files (not shown) published by the server 102 and re-construct the databases that the users are interested in on device 204. In addition, the users can fetch the block data from verification servers 202 (e.g. a verified miner) to confirm the authenticity of databases using the database fingerprints 110.

Database fingerprints. Each database fingerprint 110a, 110b, 110c uniquely represents the constructed database 108a, 108b, 108c on the server 102. As shown in FIG. 6, the fingerprints 110a, 110b, 110c includes two aspects, i.e., the hash value of data stored in the database and a metadata value of the constructed database 108a, 108b, 108c. For the data stored in the database, a cryptographic hash value of the data is calculated. The hash value can be used by verification servers 202 (e.g. miners and/or peer nodes) to check the consistency of the data stored in the database and underlying blockchain. Since, the hash value is calculated based on the data itself, and is independent on file storage system/operating system, the verification servers 202 can obtain the same hash value as long as the data stored in the database is the same as those stored in blockchain. In other words, the hash value is not affected by the data storage format. The constructed database properties can include metadata values such as the database name, the database constructed time, the database size, the database software version, and the database software hash value (e.g., SHA-256 check code). These properties of database can be used by the verification servers 202 to re-construct the database 108a, 108b, 108c in the subsequent database verification stage.

Database verification. The database 108a, 108b, 108c and its corresponding fingerprints can be used by the verification server 202 (e.g. miners and/or peer nodes) to verify the database 108a, 108b, 108c associated with the server 102, to validate the consistency of query results with the underlying blockchain. The server 102 is configured to publish the data files of the constructed databases 108a, 108b, 108c and the corresponding database fingerprints 110a, 110b, 110c after the databases are constructed. The verification server 202 can obtain the published data files to re-construct the database, and calculate a cryptographic hash value of data stored in the re-constructed database. As each verification server 202 would also store a copy of the blockchain 602 locally, the verification server 202 can calculate another hash value based on the local copy of the blockchain 602 using the same hash function (e.g. SHA-256). Accordingly, the verification server 102 can validate the consistency of data stored in the database 108a, 108b, 108c associated with the server 102 and in the underlying blockchain through comparing three hash values: 1) hash value of data published by the server 102, 2) hash value of data calculated by the verification server 202 based on the re-constructed database, and 3) hash value of data calculated by the verification server 202 based on the blockchain 602. The data stored in the database 108a, 108b, 108c would be considered consistent if the 3 hash values are identical. Upon successful verification, the verification server 202 can store the database fingerprints 110a, 110b, 110c as a transaction in the blockchain 602. Once the database fingerprints 110a, 110b, 110c are written in the blockchain 602, the record cannot be falsified in terms of the consensus scheme. Various entities (e.g. users with device 204) can query and obtain results from the server 102 with trust after checking the database fingerprint 110a, 110b, 110c stored in the blockchain 602. Accordingly, each database 108a, 108b, 108c constructed by the server 102 can be verified, and the verification information is recorded in on the blockchain 602.

Information recorded in blockchain. Information regarding the database fingerprints 108a, 108b, 108c is stored in the underlying blockchain 602 and the practical immutability of the information is safeguarded by the consensus scheme. The verification server is configured to record not only the database fingerprints 108a, 108b, 108c in the blockchain 602 upon successful validation of authenticity of databases in the server 102, but also to record the root of the Merkle Patricia Tree in the blockchain 602. The Merkle Patricia Tree is a separate cryptographic structure used to store all the database fingerprints. The MPT root is a deterministic hash generated based on all database fingerprints stored in the MPT and provides a form of cryptographic authentication to the data structure. In other words, the tree root represents a unique state of the entire tree, and is stored in the blockchain. It can be appreciated that the fingerprint and MPT root hash recording procedure may differ when the verification scheme is applied to different blockchain systems (e.g. public blockchains, private blockchains, and consortium blockchains). In the case of a private blockchain or a consortium blockchain, verification servers can be forced to write some certain information into the block of specific height. In the case of public blockchain, information cannot be guaranteed to be written in the stipulated block due to the propagation of transaction information and the competition among block miners.

Algorithm 2a

```
Require:
  kDB₁: Key database constructed in the middleware layer to be verified;
  mDB₁: Micro database constructed in the middleware layer to be
  verified;
  kDB₂: Key database constructed from the back-up by miner;
  mDB₂: Micro database constructed from the back-up by miner;
  kDB₃: Key database constructed from blockchain by miner;
  mDB₃: Micro database constructed from blockchain by miner;
  root_{bc}: Root of MPT that maintained by miner;
  BLK: Block in the blockchain.
Ensure: result_{kDB}: Key database verification result;
result_{mDB}: Micro database verification result
1: Back up kDB₁ and mDB₁;
2: HASH(kDB₁);
3: HASH(mDB₁);
4: Construct kDB₂ and mDB₂ from the back-ups of kDB₁
and mDB₂;
5: HASH(kDB₂);
6: HASH(mDB₂);
7: Construct kDB₃ and mDB₃ from BLKs
8: HASH(kDB₃);
9: HASH(mDB₃);
10: if HASH(kDB₁) = HASH(kDB₂) = HASH(kDB₃) then
11:  result_{kDB} ← ACCEPT;
12: else
13:  result_{kDB} ← REJECT;
14: end if
15: if HASH(mDB₁) = HASH(mDB₂) = HASH(mDB₃) then
16:  result_{mDB} ← ACCEPT;
17: else
18:  result_{mDB} ← REJECT;
19: end if
20: if result_{kDB} = result_{mDB} = ACCEPT then
21:  Update MPT and synchronize MPT to middleware2;
22:  Write HASH(kDB₁), HASH(mDB₁) and MPT root root_{bc} into
              blockchain;
23: end if
24: return result_{kDB} and result_{mDB};
```

### Algorithm 2a: Database Verification

Verification scheme. Algorithm 2a above shows a proposed database verification scheme for exemplary databases constructed by the server 102 (middleware layer), the exemplary databases similar to the one or more databases 300 described above in paragraph [0072]. Algorithm 2b below shows another proposed database verification scheme for exemplary databases constructed by the server 102 (middleware layer) that are similar to the one or more databases 400 described above in paragraph [0073]. The algorithms 2a and 2b can be used by the verification servers (miners) to verify the consistency of constructed databases in the server 102 (middleware layer) with the underlying blockchain. In both embodiments (algorithm 2a and 2b), verification servers (miners) can verify the consistency of the database in the middleware layer after comparing with the database hash value involved in the database fingerprint published by the server 102 (middleware layer). Moreover, the database verification scheme for verification servers (miners) can be further optimized for storage space efficiency, and can use prior verified results to reduce frequent and/or repeated database construction from the blockchain, Verification servers (miners) can verify the middleware layer from a previous version of the database, instead of constructing the database from the first block in the blockchain. The optimized database verification scheme can improve the speed and efficiency of verification servers.

Algorithm 2b

```
Require:
  mDB₁: Micro database constructed in the middleware layer to be
  verified;
  mDB₂: Micro database constructed from the back-up by miner;
  mDB₃: Micro database constructed from blockchain by miner;
  root_{bc}: Root of MPT that maintained by miner;
  BLK: Block in the blockchain.
Ensure: result_{mDB}: Micro database verification result
1: Back up mDB₁;
2: HASH(mDB₁);
3: Construct mDB₂ from the back-ups of mDB₂;
4: HASH(mDB₂);
5: Construct mDB₃ from BLKs
6: HASH(mDB₃);
7: if HASH(mDB₁) = HASH(mDB₂) = HASH(mDB₃) then
8:  result_{mDB} ← ACCEPT;
9: else
10: result_{mDB} ← REJECT;
11: end if
12: if result_{mDB} = ACCEPT then
13: Update MPT and synchronize MPT to middleware2;
14: Write HASH(mDB₁) and MPT root root_{bc} into blockchain;
15: end if
16: return result_{mDB};
```

Failed verification situation. If the three hash values are not identical, an error report can be transmitted by the verification server to the middleware layer. Upon receipt of a predetermined number of failed verification reports, the middleware layer can be configured to execute a diagnostic procedure until no further error reports arrive. The failed verification report scheme can ensure that the key database constructed in middleware layer is consistent with the blockchain.

In an alternative embodiment, the verification server 102 is not required to validate the consistency of data stored in the database 108a, 108b, 108c associated with the server 102 and in the underlying blockchain by comparing three hash values: 1) hash value of data published by the server 102, 2) hash value of data calculated by the verification server 202 based on the re-constructed database, and 3) hash value of data calculated by the verification server 202 based on the blockchain 602. Rather, the verification server 202 can be configured to store the fingerprints on the blockchain 602 without the need to verify if the fingerprints are valid. This would reduce the computational cost of the verification server 102. A smart contract is enforced between the verification server 202 and the server 102, if the fingerprints stored on the blockchain 602 are found to be invalid, the server 102 would be penalized to ensure reliability of the databases generated by server 102.

### Simplified Query Result Verification Scheme

In embodiments of the present invention, verification of query result by users would require users to download the blockchain from authenticated miners and verify the entire databases by reconstructing them. While this can guarantee the authenticity of databases, the verification process may sometimes be computationally expensive for a user. To remedy this issue, a simplified query result verification scheme to ease the process of result verification for query users is provided below.

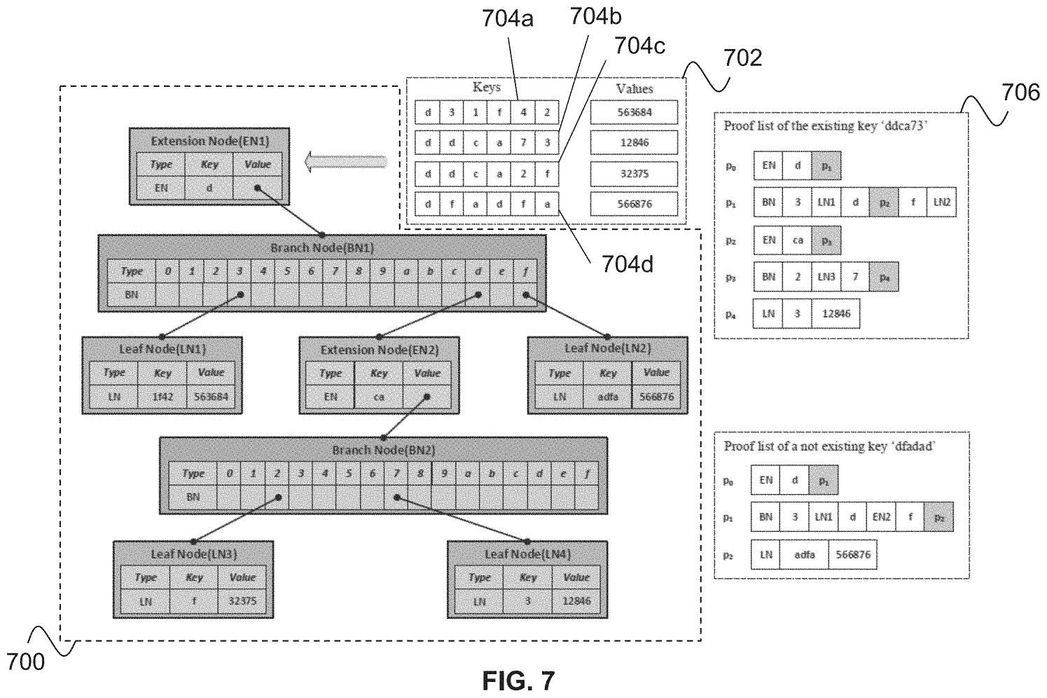

Merkle Patricia Tree for database fingerprints. As described above, due to the propagation of transaction information and the competition among block miners in public blockchain systems, a database fingerprint is not guaranteed to be precisely recorded in a block of a specific height. Thus, a Merkle Patricia Tree is used to store these [fingerprint, height] pairs after the verification server confirms that the fingerprint is written into a block at a certain height. By virtue of MPT, the middleware layer can prove the existence of a given database fingerprint to query users connected to the application server. In embodiments of the invention, the given database fingerprint can be a fingerprint associated with a database query result generated responsive to a user query. A Merkle proof (also known as a verifying value, with more details below) can be used to verify if the given fingerprint forms part of the Merkle Patricia Tree. In this way, query users can directly check the authenticity of the given database fingerprint without searching the blockchain for the information. It is noted that the MPT data structure is maintained by verification servers and will be updated each time the consistency of databases is validated and the database fingerprints written into the blockchain. Moreover, the MPT data will also be transmitted to the server 102 by verification server 202 so that the server 102 can provide Merkle proofs (also known as verifying values) to query users. FIG. 7 shows an exemplary MPT 700 including four database fingerprints 704a, 704b, 704c, 704d as shown in the key-value list 702, in which the key is the database fingerprint 704a, 704b, 704c, 704d and the value represents the height of the block where the fingerprint 704a, 704b, 704c, 704d is written. Using these fingerprints, the Merkle Patricia Tree is built as shown in FIG. 7.

Simplified query result verification process. FIG. 2 shows a schematic diagram of a system 200 including the server 102 of FIG. 1, in accordance with embodiments of the invention. The system 200 comprises the verification server 202 (e.g. the miners), a user device 204, the server 102 (middleware server) and the application server 118. The verification server 202 is configured to validate authenticity of the one or more databases 108a, 108b, 108c communicatively coupled to the server 102. As discussed above, the verification server 202 is configured to transmit a copy of the Merkle Patricia Tree 206 and a verification 208 of the databases 108a, 108b, 108c to the server 102. The user device 204 is configured to communicate with the application server 118. The user device 204 can transmit a query 210 to the application server 118. The application server 118, together with the server 102, is configured to receive query from the user device 204 and to transmit a database query result 212 in response to the query to the user device 204. In the simplified query result verification process, the verification server 202 would only need to transmit a copy of the MPT 206 (i.e. to synchronize the MPT with the server 102) and provide the MPT root hash 216 to the user device 204 if a verification request 214 is received. Each time a user device 204 transmits data query 204 to the server 102, the server 102 will return a query result 212 via application server 118. The query result 212 would include fingerprints of the databases associated with the query result 212 and the corresponding verifying values (Merkle proofs). The user device 204 can be configured to combine the MPT root hash 216 obtained from the verification server 202 to check the validity of the fingerprints. If a validation of the query result 212, or a confirmation of the root hash and database fingerprints are required, the blocks in terms of the corresponding height value stored in MPT can be searched.

Algorithm 3 below shows the simplified query result verification algorithm performed by the user device 204. When a data query 210 is transmitted to the server 102, a query result 212 (shown as resultₘ in Algorithm 3) can be received from the server, together with the fingerprints of all the databases involved (shown as DBₛ in Algorithm 3). Algorithm 3 can be applied to the one or more databases 300 (shown in FIG. 3) and the one or more databases 400 (shown in FIG. 4). The user device 204 can re-construct the corresponding databases and calculate the fingerprints associated with the databases after downloading the corresponding database back-up files from the server 102. Meanwhile, a verification request 214 can be sent to the verification server 202 (e.g. the miners) to obtain the updated MPT root hash 216 (shown as root_{bc} in Algorithm 3), which is associated with the newest state of all verified databases. In one embodiment, the query result 212 received by the user device 204 would also include fingerprints of the databases associated with the query result 212 and the corresponding Merkle proofs. In an alternate embodiment of the invention, the user device 204 can calculate the database fingerprints, transmit a copy of the calculated fingerprints to the application server 118 and obtain the Merkle proof for every fingerprint transmitted. Based on the Merkle proof for each fingerprint, the user device 204 can calculate the root hash rootₘ and then compare the root hash rootₘ with the root hash root_{bc} received from verification server 202. When the two root hashes are equal and the key is in accord with the path, the correctness of the fingerprint can be guaranteed. The process of proving the presence of the fingerprint using MPT root and Merkle proof is included in Prove Algorithm 4 and will be described in detail below. If all the databases involved are validated, the user device 204 can query the databases that are locally constructed from back-up files and obtain query result (shown as result in Algorithm 3). If the result is identical to the previous result resultₘ from the server 102, the query result can be accepted and trusted.

Algorithm 3 Simplified query result verification

```
Require:
  root_{bc}: Root of MPT that stored in blockchain;
  DBs: Database(s) that the user query involves;
  proof: Merkle proof of a given database fingerprint;
  resultₘ: Query result provided by middleware layer;
  result: Query result obtained by user from local databases;
Ensure: v ∈ {0, 1}, if v = 1, accept the query result; otherwise,
reject.
1: for each query do
2:  Get the latest MPT root root_{bc} recorded in blockchain from
        miners;
3:  verified ← FALSE;
4:  for each DB ∈ DBs do
5:  Construct DB from the back-ups in the middleware layer
6:  fingerprint ← HASH(DB);
7:  Send fingerprint to the middleware layer;
8:  Get the Merkle proof proof from the middleware layer;
9:  verified ← Prove(root_{bc}, fingerprint, proof);
10:  if not verified then
11:  break;
12:  end if
13:  end for
14:  if verified then
15:  Query DBs locally and get the query result result;
16:  if result = resultₘ then
17:  return 1;
18:  else
19:  return 0;
20:  end if
21:  else
22:  return 0;
23:  end if
24: end for
```

### Algorithm 3: Simplified Query Result Verification

Merkle proof for fingerprints. Proof/Authentication of an example fingerprint is described with reference to FIG. 7. For example, the user device can be configured to check if database fingerprint 704b (“ddca73”) exists in the MPT (see FIG. 7). The value of key 704b is stored in the leaf node LN4 and the corresponding search path from root node to leaf node is {EN1,BN1,EN2,BN2,LN4}. Based on the path, the server 102 can provide a verifying value, also known as a Merkle proof, which is a list of Recursive Length Prefix (RLP) code of the nodes along the path (see FIG. 7, numeral 706), for the user device 204 to prove the existence of the key. In this case, the Merkle proof for ‘ddca73’ is a 19-element array, i.e., p0 to p4. Each node is referenced inside the previous element except the root node p0. Using this list, the correctness of the value and RLP code of each element in the array can be checked successively from head to tail, i.e., in the order from root to leaf. If the root hash finally calculated is identical to the publicly known root value and the prefixes along the path equal to the fingerprint, then this database fingerprint is considered to truly exist. Algorithm 4 shows the pseudo-code of the Prove algorithm executed by the user device 204 to verify whether the database fingerprint exists in MPT. Algorithm 4 can be applied to fingerprints associated with the one or more databases 300 (shown in FIG. 3), as well as fingerprints associated with the one or more databases 400 (shown in FIG. 4). Similarly, the Merkle proof can be utilised to prove the in-existence of a given key. Suppose a database is reconstructed using broken or tampered files and that a wrong fingerprint is calculated, e.g., “dfadad” (shown in FIG. 7, numeral 708), which does not exist in the MPT. If the calculated fingerprint is transmitted to the server 102, the Merkle proof based on the search path {EN1,BN1,LN2}, i.e., p0 to p2 as shown in FIG. 7 will be generated and transmitted to the user device 204. Here, the hash of root p0 can be verified by calculating from head to tail and still equals to the root hash obtained from miners. Nevertheless, the prefixes generated by the proof differ from the fingerprint key (the correct fingerprint being “dfadfa”, which implies that the fingerprint does not exist in the MPT.

Determination of the verifying value (also known as a Merkle proof) by the server 102 is described. In embodiments of the invention, the verifying value is determined by the server 102 responsive to one or more fingerprints associated with the database query result. Specifically, the server 102 first identifies one or more nodes associated with the one or more fingerprints within the Merkle Patricia Tree that forms a path from a top node of the Tree to the base node of the Tree. The top node is associated with a first character of a fingerprint associated with the database query result, and the base node is associated with a last character of the fingerprint associated with the result. The server 102 then generates verifying values of sibling nodes of the one or more identified nodes within the Merkle Patricia Tree. The verifying values comprises a list of Recursive Length Prefix (RLP) code of the sibling nodes along the path. The verifying values contain information complementary to the determined fingerprint, and can be combined with the determined fingerprint to obtain the root hash of the Merkle Patricia Tree. In other words, the verifying values can be used by the user device 204 to confirm that the determined fingerprints are part of the cryptographic structure (see FIG. 7, numeral 706).

### Query Data Authenticity Analysis

Since VQL obtains query results from the constructed database, if the database is consistent with the underlying blockchain, the authenticity of queried data can be confirmed. Thus, database verification analysis can be conducted from three aspects: the rewarding scheme for verification servers (miners), the integrity of database and the verifiability of query result.

Rewarding scheme for miners. Verification of databases associated with the server 102 (middleware layer) is performed by verification servers (miners). The reward schemes for miners can be different and can depend on the characteristics of the blockchain systems. For the public blockchain system, as the transaction sponsor in the blockchain, the middleware layer would be required to reward the verification server(s) (i.e. the miner or the mining pool) for verification of the constructed database and record the database fingerprint in the blockchain. For the private blockchain system, as the miners and middleware layer are private, the verification and record fees are not needed. For the consortium blockchain system, depending on various agreements between communities in the consortium, the middleware layer may or may not be required to reward the miners.

Algorithm 4 Prove algorithm

```
Require:
  root_{bc}: Root of MPT that stored in blockchain;
  fingerprint: Fingerprint of the database to be checked;
  proof: a n-element list of pᵢ, i.e., Merkle proof of the given database
  fingerprint;
Ensure: return TRUE if fingerprint exists in MPT; otherwise,
return FALSE.
1: if HASH(p₀) _= root_{bc} then
2:  return FALSE;
3: end if
4: for i ← 0 to n − 1 do
5:  if i = n − 1 then
6:  if key in pᵢ conforms to fingerprint then
7:  return TRUE;
8:  else
9:  return FALSE;
10:  end if
11:  end if
12:  if i < n − 1 then
13:  if key in pᵢ conforms to fingerprint and
                key's value = RLP(pᵢ₊₁) then
14:  continue;
15:  else
16:  return FALSE;
17:  end if
18:  end if
19: end for
```

### Algorithm 4: Prove Algorithm

Verifiability of query result. After the integrity of databases in the middleware layer is guaranteed, the query result received by user device 204 should also be consistent with the databases. Two methods are provided to confirm the verifiability of query result, i.e., user device verification in the database verification scheme and simplified query result verification scheme. The user database verification requires user device to download all the blockchain data and check the consistency, in an authentication process similar to that performed by the verification servers, as described before. The simplified query result verification scheme allows user devices to download only the involved databases rather than all the databases and check the validity of the fingerprints by leveraging the MPT cryptographic structure. Since the databases are re-constructed based on the backup files and their fingerprints are calculated locally by the user device, the authenticity of the involved databases can be ensured if these fingerprints indeed exist in the MPT maintained by verification servers. Finally, the user device can query the validated local databases and check whether the result is consistent with the query result returned by the middleware layer.

### Implementations and Evaluation

An exemplary prototype based on Ethereum and MongoDB is discussed below. The blockchain system includes three layers, i.e., the application layer, the middleware layer, and the blockchain layer. The application layer can use the querying APIs as users and the verifying APIs as miners. The middleware layer preserves databases to provide timely responses for various query services. It can be updated when new blocks are generated in the blockchain, and enables miners to conduct database verification. The blockchain module connects peer nodes to store the records as a blockchain ensuring a consensus state view over peers (avoiding forks to ensure all peers works on a same blockchain) and provides APIs to search records on the blockchain. To test the performance of the system and algorithms, a prototype on a well-known blockchain-based application Ethereum is implemented.

### Example Implementation

A middleware with APIs is implemented for peer nodes and user application. The databases in the middleware ensure timely responses to various queries.

Middleware design. The middleware supports user-friendly APIs for user applications and APIs for underlying blockchain. The user application APIs support various temporal queries and verification of databases for audit, while the blockchain APIs support query functions to collect records from the blocks in the blockchain. The middleware can be deployed on the cloud computing platforms like AWS for blockchain. The databases can be maintained either by a (logically) centralized server or by several distributed peer nodes in the blockchain. The query and setup latency of the system with the block and transaction data of Ethereum stored is evaluated.

Prototype Implementation. A prototype is implemented to evaluate the performance of the system. The prototype can be deployed on a large scale blockchain network configured via the AWS blockchain service. A MongoDB database is deployed for the data storage and the middleware is implemented by pymongo, a python MongoDB API. The prototype is used to showcase the effectiveness and efficiency of the system.

Verification Implementation. Besides the query service of the middleware, the performance of the data verification scheme is also evaluated, which consists of miner database verification and simplified query result verification. The back-up and re-construction of databases are supported by MongoDB while the MPT for fingerprint storage is stored in LevelDB. The verification is conducted to validate the verification scheme and to illustrate the effectiveness and efficiency of the verification scheme.

### Performance Evaluation

In this subsection, to better understand the effectiveness and limitation of the system, a comprehensively evaluation and comparison of the performance of different systems is done. The process of synchronization from scratch in blockchain systems usually needs to be done only once because of the fact that blockchain data is immutable. Moreover, the time cost of the synchronization process is generally dominated by the network bandwidth and the performance of physical machine. Nodes with low network bandwidth or bad performance of machine may take several days to catch up with other peers. Therefore, the evaluation of blockchain synchronization is excluded in this paper. To evaluate the system performance, the experiment platform is built on a server equipped with i7-8750H CPU, 16 GB memory and 1900 GB SSD. In the proposed three-layer blockchain system, various data query services based on the real Ethereum blockchain data with block height varying from 0 to 800,000 are supported to the application layer. Thus, considering different practical scenarios, various data query services in many parts, including throughput, block query, transaction query, account query, and range query are tested.

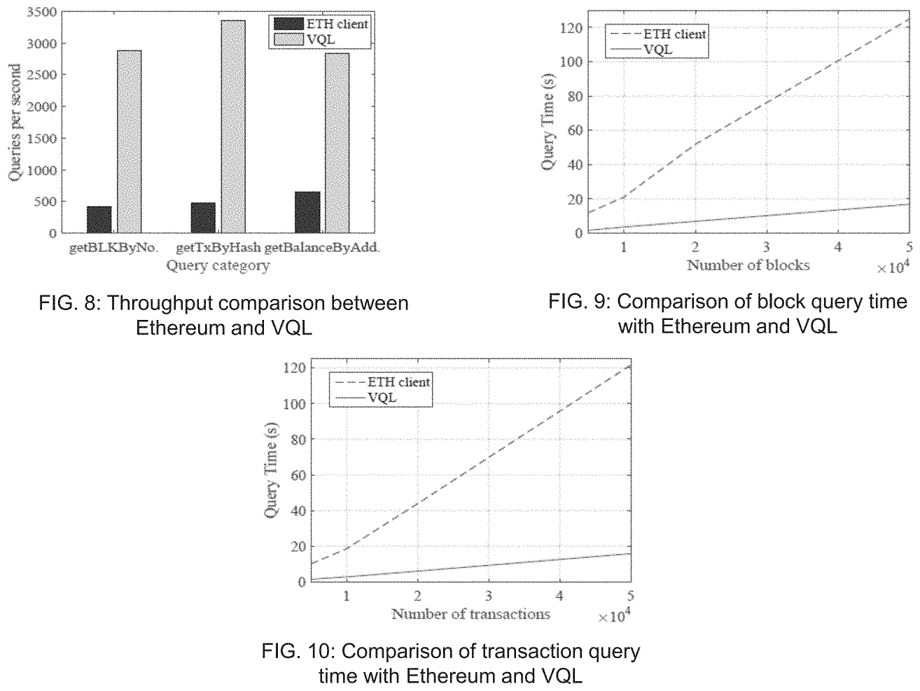

Throughput. The throughput performance of the proposed system VQL is first evaluated. The throughput between the native Ethereum clients and the VQL for supported queries is compared. Three kinds of queries are conducted, including querying a block by the block number, querying a transaction by the transaction hash, and querying the balance of an account by the account address. As shown in FIG. 8, the throughput of VQL is about 4 to 7 times as that of Ethereum. When a block is queried by the block number, the VQL and Ethereum can support 2.89K queries/s and 420 queries/s, respectively. For querying a transaction by the transaction hash, the VQL and Ethereum are able to process about 3.35K queries/s and 473 queries/s. If the balance of an account is queried by the account address, both systems can achieve higher throughput (i.e., 2.84K queries/s and 646 queries/s) because of the relatively smaller amount of accounts. The lower throughput of the native Ethereum client is due to the fact that it uses hash as the key to locate the desired value, which incurs massive read operations of files that scattered all over the disks. The results show that the proposed VQL can achieve a higher throughput than the native Ethereum system.

Block query. Query efficiency is a critical criteria for the proposed query supported system. In the blockchain, various transactions generated by users are stored in the blocks. Thus, the block query time of different systems is first compared (e.g., ETH client and VQL) to show the query efficiency of the system. Ethereum client provides a JSON RPC API to conduct the block query. Accordingly, an API in the middleware layer is developed to provide query service about blocks. Experiments on block query with 19,000-block, 10,000-block, 20,000-block and 190,000-block scenarios, are conducted respectively. As shown in FIG. 9, the block query time is compared with Ethereum and VQL. As a single block query can usually be completed in milliseconds, a randomly selected list of blocks are queried, and the time of completing these queries is recorded. With more blocks queried, the query time is significantly increased with Ethereum while the time of VQL can still remain at a relatively lower level. Using the JSON RPC API in Ethereum client to query the information in a specific block needs to traverse from the first block to the targeted block. This method requires plenty of query time, for example, 125 seconds in the evaluation within the 190,000-block scenario. In contrast, the proposed VQL system can save much query time, which optimizes the data storage for faster query (e.g., 16.9 seconds in 190,000-block scenario).

Transaction query. In the proposed blockchain system, different types of transaction details can be stored in the blocks, including currency transactions in finance, product or item traces in logistics, and digital copyright distribution in the Internet, etc. All these transaction details generated from users will be reorganized in the databases constructed in the proposed middleware layer. Through the API developed in the middleware layer, various applications can query corresponding transaction details to conduct subsequent data analysis and provide services for end users. In the traditional blockchain system, applications need to traverse all blocks in the blockchain to find some specific transactions. However, different from the traditional blockchain system, the query about transaction details will be more efficient with the proposed middleware layer, which benefits from the organized databases.

The query about individual transaction information is also supported in the system and the query time of transactions is tested. As shown in FIG. 10, the transaction query time is compared with Ethereum and VQL. Since a single transaction query can usually be completed very fast, a bunch of randomly selected transactions are queried to evaluate the time. Cases with different numbers of transactions in the experiment, including 19,000, 10,000, 20,000, and 190,000 transactions are tested. The number of transactions linearly promotes the query time in both two cases. For VQL, it takes only about one-sixth of the time that Ethereum uses to query the same amount of transactions.

Account query. Account balance is a commonly used data structure in many query services. In the middleware layer, each constructed database (including key database and micro database) contains two parts of data: the transaction details and the balances of all accounts. Different from the transaction details, account balance provides the latest overall balance description for each account. According to different applications, the account balance of each account in the system can record various data, including the currency balance and the stock of a physical or digital product. A specialized API is also developed in the middleware layer to support the queries about the balance in many accounts for the application layer. Specially, to reduce the storage cost of the database, only those accounts with non-zero balance will be recorded in the middleware.

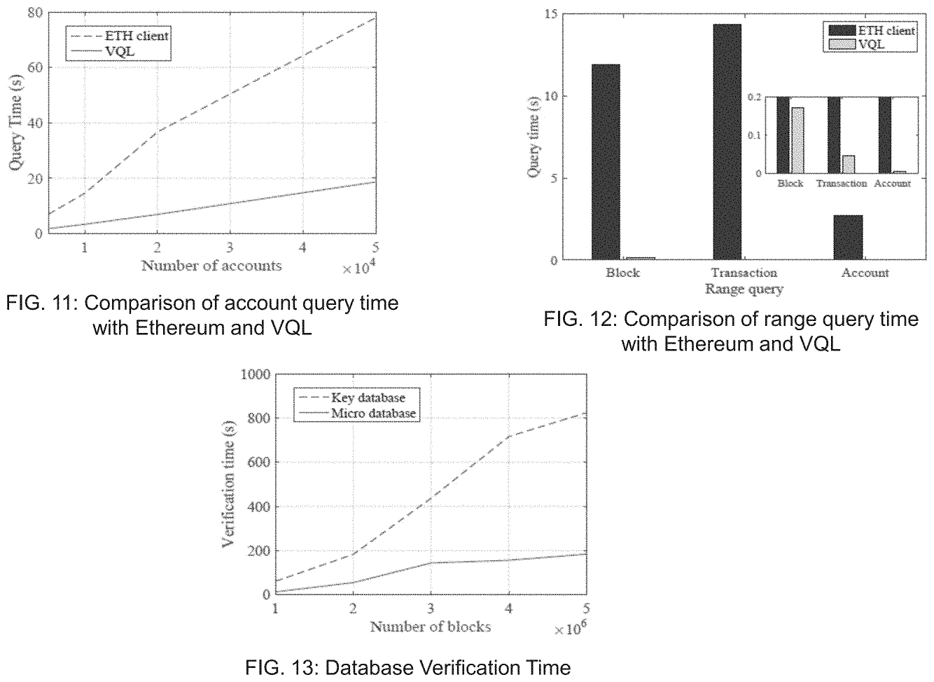

Experiments are conducted to evaluate the query time of account balance. As shown in FIG. 11, the query time of account balance is compared with Ethereum and VQL. As the query time of a single account is too small to measure, a randomly selected list of accounts is used to test the efficiency of balance query. Scenarios with different numbers of accounts are tested in the experiment, including 19,000, 10,000, 20,000, and 190,000 accounts. The query time of account balance is observed to increase almost linearly with the number of accounts. Compared with Ethereum, the query about account balance with the same amount in VQL can be completed with relatively less time. This is because, the information of account balance is calculated in advance in the proposed middleware, and are well organized in the databases.

Range query. Besides the individual item query, range query is also important to the middleware layer. In the proposed three-layer blockchain-based architecture, the application layer often needs to conduct various data analysis and machine learning tasks. For these tasks, many features should be extracted through a specific data set. Thus, to obtain the needed data set, the middleware layer should provide the ability of data query within a specific range for the upper application layer.

Performance evaluation for range query for block, transaction, and account, are conducted respectively. Considering the many applications related to data analysis, three various kinds of range queries, includes querying blocks generated in one day, querying transactions within a range of values, and querying account balances changed in one day are used. As shown in FIG. 12, the range query time of different categories are compared with Ethereum and VQL. Blocks generated in one day are queried and the query time recorded. The VQL can finish the query with 0.173 s while the Ethereum requires 11.92 s. Transactions within a randomly chosen day are queried and the time required to perform the task is recorded. The VQL completed the query within 0.047 s while Ethereum took 14.37 s. Finally, the account balances that are changed in one day (i.e. a list of accounts with transactions performed in that day) are queried. Results show that the VQL took 0.0052 s while the Ethereum took 2.69 s. In general, the proposed VQL took much less time to finish different range queries than the Ethereum. The VQL showed remarkable advantages over the Ethereum client due to the well-organized micro databases in the middleware, which are very efficient for time range query. In contrary, Ethereum has to traverse the pertinent blockchain data to obtain the items, which is quite time-consuming.

Database verification. Database verification efficiency is also an important criteria. Thus, the database verification time for both key database and micro database is tested. As the blocks in the blockchain are continuously generated, the verification time of key database and the average verification time of micro databases when every 1 million blocks are generated in the blockchain is recorded. As shown in FIG. 13, when the middleware layer has constructed databases for 1 million blocks in the blockchain, the verification time of key database for a miner is 61 s and the average verification time of micro databases is 13 s. When the middleware layer includes 19 million blocks in the blockchain, the key database verification time is 824 s and the average micro database verification time is 184 s. With more blocks generated in the blockchain, the key database verification time increases and stays at a relatively low level. The average verification time of micro databases grows slowly. This is because the micro databases are constructed for blocks generated in each period and the database size may not increase markedly. Thus, the proposed system can efficiently verify databases constructed in the middleware layer and be applied to blockchain systems.

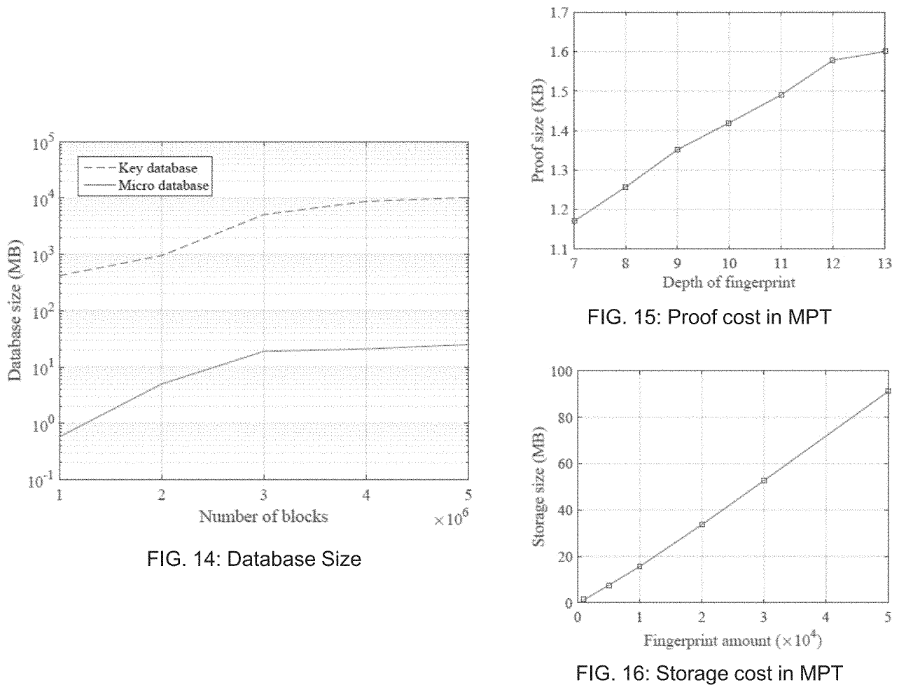

Database size. Considering the storage space efficiency, the size of database to be verified in the middleware layer during the database verification process is also tested. In the database verification time evaluation, the size of key database and the average size of micro databases when every 1 million blocks are generated in the blockchain is recorded. As shown in FIG. 14, when the middleware layer has constructed databases for 1 million blocks in the blockchain, the size of key database stored in the middleware layer is 421 MB and the average size of micro databases is 0.6 MB. The key database size increases to 10.3 GB and the average size of micro database is 25 MB when the middleware layer contains 19 million blocks from the blockchain. With more blocks generated in the blockchain, the key database size increases notably, while the average size of micro databases increases slowly. The reason is that the micro databases are constructed for blocks generated in each period, and the database size may not grow fast and can be kept small. Thus, the proposed system can efficiently store the databases constructed in the middleware layer to provide query services and database verification.

Proof cost in MPT. The cost of simplified query result verification are dominated by the communication overhead incurred by Merkle proof. The size of Merkle proof is mainly decided by the number of layers in MPT. The deeper the leaf node locates in MPT, the longer its search path becomes. Thus the size of proof that the middleware server returns for each database fingerprint is evaluated. In the evaluation, SHA-256 hash function is employed to generate the fingerprint for the database. Thus the key to be stored in MPT has 256 bits. 2,000 keys are added to the MPT and the average length of Merkle proof that MPT provides by invoking the prove function for each key is provided. As shown in FIG. 15, the size of Merkle proof is only a few kilobytes and closely associated with the depth of key. The depth of fingerprint is principally distributed between 7 and 13 and the proof size gradually increases as the depth grows. This is because Merkle proof is a list of nodes along the path and the RLP code of one node is about 100 bytes. Compared with the size of the block data needed in miner database verification, the overhead of giving the Merkle proof is practically negligible.

Storage cost of MPT. Since the MPT for database fingerprint is updated by miners and will be synchronized to the middleware layer, it will cost storage space in both miners and the middleware server. In order to show the storage cost of MPT with the amount of fingerprint increasing, the size of the LevelDB database files generated by the MPT when the total amount is 1000, 19000, 10000, 20000, 30000, and 190000 are evaluated. As shown in FIG. 13, storage cost increases proportionally with the amount of fingerprint, indicating that MPT does not bring about extra storage space cost except for the storage of keys themselves. The storage cost increases to 90 MB when the fingerprint amount reaches 190000, which is relatively small compared with the size of databases constructed in miner database verification process. Therefore the storage cost is acceptable in achieving simplified query result verification scheme.

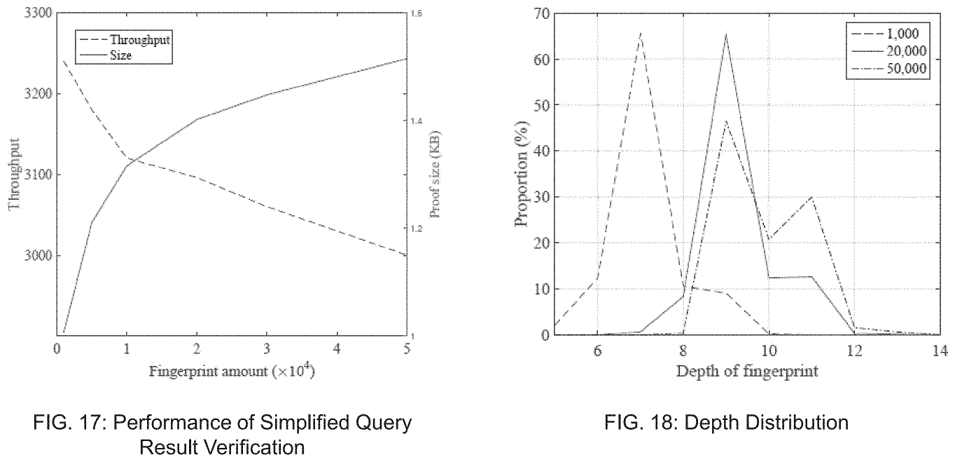

Performance of simplified query result verification. In addition to the miner database verification, the performance of the simplified query result verification scheme is evaluated for its feasibility and efficiency. In the simplified verification scheme, the middleware layer will return a Merkle proof for each query from users. Thus the number of verification requests the middleware is able to handle concurrently and how much overhead it costs to return a Merkle proof are evaluated. The performance is shown in FIG. 17, which includes the throughput and proof size under various number of fingerprints. The throughput of returning proofs is observed to decrease when the amount of fingerprints grows. This is because the MPT becomes larger when more fingerprints are stored, which leads to longer search time for each fingerprint. The middleware can support 3 000 verification requests per second with 190000 fingerprints stored. Meanwhile, the average size of Merkle proof is observed to rise slowly when the number of fingerprints increases. The reason behind this is investigated and the distribution of fingerprint depth is observed to change under different cases. FIG. 18 shows how fingerprint depth distributes under scenarios with different fingerprint amounts. When the amount of fingerprints is 1000, the depth mainly distributes around 7 and the proportion of 7 exceeds 65%. As the amount increases, the majority of fingerprint depth rises slightly. The depth of 9 accounts for more than 60% of the whole fingerprints when the total amount reaches 20000. In the scenario with 190000 fingerprints, the proportion of depth 11 gradually grows to about 30%, leading to a higher average depth. Combining with the previous observation from the proof cost in MPT, the increasing average proof size conforms to the distribution of fingerprints. Compared with the size of database itself in the middleware, the proof cost in the simplified query result verification is relatively small.

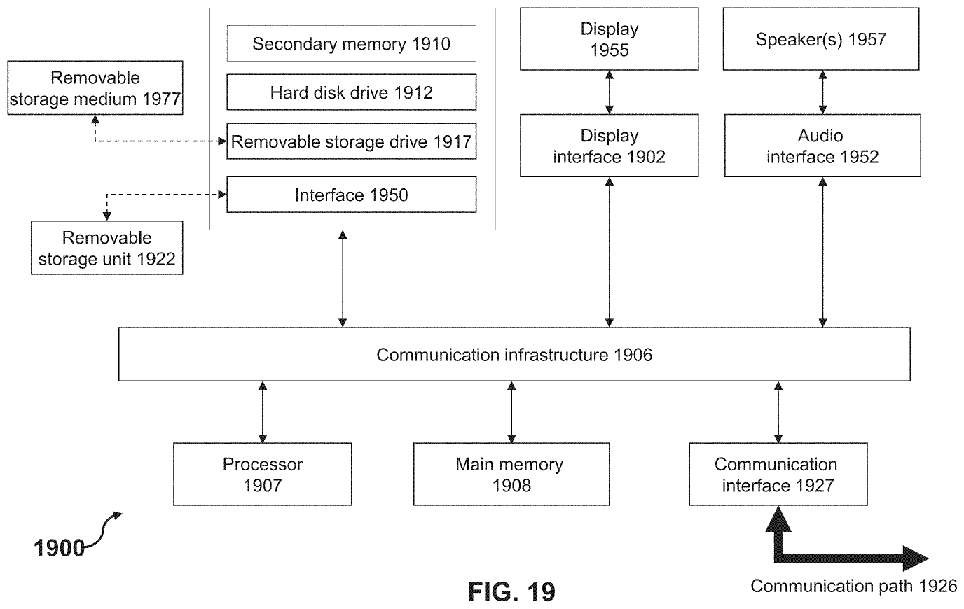

FIG. 19 depicts an exemplary computing device 1900, hereinafter interchangeably referred to as a computer system 1900, where one or more such computing devices 1900 may be used to execute the method 1900 of FIG. 19. One or more components of the exemplary computing device 1900 can also be used to implement the system 100, the server 102, the application server 118, the user device 204 and the verification server 204. The following description of the computing device 1900 is provided by way of example only and is not intended to be limiting.

As shown in FIG. 19, the example computing device 1900 includes a processor 1907 for executing software routines. Although a single processor is shown for the sake of clarity, the computing device 1900 may also include a multi-processor system. The processor 1907 is connected to a communication infrastructure 1906 for communication with other components of the computing device 1900. The communication infrastructure 1906 may include, for example, a communications bus, cross-bar, or network.

The computing device 1900 further includes a main memory 1908, such as a random access memory (RAM), and a secondary memory 1910. The secondary memory 1910 may include, for example, a storage drive 1912, which may be a hard disk drive, a solid state drive or a hybrid drive and/or a removable storage drive 1917, which may include a magnetic tape drive, an optical disk drive, a solid state storage drive (such as a USB flash drive, a flash memory device, a solid state drive or a memory card), or the like. The removable storage drive 1917 reads from and/or writes to a removable storage medium 1977 in a well-known manner. The removable storage medium 1977 may include magnetic tape, optical disk, non-volatile memory storage medium, or the like, which is read by and written to by removable storage drive 1917. As will be appreciated by persons skilled in the relevant art(s), the removable storage medium 1977 includes a computer readable storage medium having stored therein computer executable program code instructions and/or data.

In an alternative implementation, the secondary memory 1910 may additionally or alternatively include other similar means for allowing computer programs or other instructions to be loaded into the computing device 1900. Such means can include, for example, a removable storage unit 1922 and an interface 1950. Examples of a removable storage unit 1922 and interface 1950 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1922 and interfaces 1950 which allow software and data to be transferred from the removable storage unit 1922 to the computer system 1900.

The computing device 1900 also includes at least one communication interface 1927. The communication interface 1927 allows software and data to be transferred between computing device 1900 and external devices via a communication path 1926. In various embodiments of the inventions, the communication interface 1927 permits data to be transferred between the computing device 1900 and a data communication network, such as a public data or private data communication network. The communication interface 1927 may be used to exchange data between different computing devices 1900 which such computing devices 1900 form part an interconnected computer network. Examples of a communication interface 1927 can include a modem, a network interface (such as an Ethernet card), a communication port (such as a serial, parallel, printer, GPIB, IEEE 1394, RJ45, USB), an antenna with associated circuitry and the like. The communication interface 1927 may be wired or may be wireless. Software and data transferred via the communication interface 1927 are in the form of signals which can be electronic, electromagnetic, optical or other signals capable of being received by communication interface 1927. These signals are provided to the communication interface via the communication path 1926.

As shown in FIG. 19, the computing device 1900 further includes a display interface 1902 which performs operations for rendering images to an associated display 1950 and an audio interface 1952 for performing operations for playing audio content via associated speaker(s) 1957.

As used herein, the term “computer program product” may refer, in part, to removable storage medium 1977, removable storage unit 1922, a hard disk installed in storage drive 1912, or a carrier wave carrying software over communication path 1926 (wireless link or cable) to communication interface 1927. Computer readable storage media refers to any non-transitory, non-volatile tangible storage medium that provides recorded instructions and/or data to the computing device 1900 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1900. Examples of transitory or non-tangible computer readable transmission media that may also participate in the provision of software, application programs, instructions and/or data to the computing device 1900 include radio or infra-red transmission channels as well as a network connection to another computer or networked device, and the Internet or Intranets including e-mail transmissions and information recorded on Websites and the like.

The computer programs (also called computer program code) are stored in main memory 1908 and/or secondary memory 1910. Computer programs can also be received via the communication interface 1927. Such computer programs, when executed, enable the computing device 1900 to perform one or more features of embodiments discussed herein. In various embodiments, the computer programs, when executed, enable the processor 1907 to perform features of the above-described embodiments. Accordingly, such computer programs represent controllers of the computer system 1900.

Software may be stored in a computer program product and loaded into the computing device 1900 using the removable storage drive 1917, the storage drive 1912, or the interface 1950. The computer program product may be a non-transitory computer readable medium. Alternatively, the computer program product may be downloaded to the computer system 1900 over the communication path 1926. The software, when executed by the processor 1907, causes the computing device 1900 to perform the necessary operations to execute the method 1900 as shown in FIG. 19.

It is to be understood that the embodiment of FIG. 19 is presented merely by way of example to explain the operation and structure of the system 1900. Therefore, in some embodiments one or more features of the computing device 1900 may be omitted. Also, in some embodiments, one or more features of the computing device 1900 may be combined together. Additionally, in some embodiments, one or more features of the computing device 1900 may be split into one or more component parts.

It will be appreciated that the elements illustrated in FIG. 19 function to provide means for performing the various functions and operations of the system as described in the above embodiments.

When the computing device 1900 is configured to realise the server 102 to process a database query, the server 102 will have a non-transitory computer readable medium having stored thereon an application which when executed causes the server 102 to perform steps comprising: (i) receive an input requesting a database query result to the database query, (ii) determine the database query result based on the one or more databases in response to the input, and (iii) determine one or more fingerprints of the databases associated with the database query result, and a verifying value in response to the determined one or more fingerprints, the verifying value being one that is used to verify if the determined one or more fingerprints are part of the cryptographic structure.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A server for processing a database query, the server associated with one or more databases and a cryptographic structure, the cryptographic structure storing one or more fingerprints in a plurality of nodes, each of the one or more fingerprints associated with a respective database of the one or more databases, the server comprising:
at least one processor; and
at least one memory including computer program code;
the at least one memory and the computer program code configured to, with the at least one processor, cause the server at least to:
receive an input requesting a database query result to the database query;
determine the database query result based on the one or more databases in response to the input; and
determine one or more fingerprints of the databases associated with the database query result, and a verifying value in response to the determined one or more fingerprints, the verifying value being one that is used to verify if the determined one or more fingerprints are part of the cryptographic structure.

2. The server of claim 1, wherein the at least one memory and the computer program code are configured to, with the at least one processor, cause the server to further:
construct the one or more databases based on information stored on a distributed ledger; and
generate the one or more fingerprints, each of the one or more fingerprints associated with a respective database of the one or more databases.

3. The server of claim 2, wherein the at least one memory and the computer program code are configured to, with the at least one processor, cause the server to generate each fingerprint based on a hash of the data stored on the respective database and a metadata value of the respective database.

4. The server of claim 1 or 2, wherein the at least one memory and the computer program code are configured to, with the at least one processor, cause the server to further transmit the one or more fingerprints to a verification server, the verification server being configured to store the one or more fingerprints on the distributed ledger.

5. The server of claim 1, wherein the at least one memory and the computer program code are configured to, with the at least one processor, cause the server to further receive, from a verification server, the cryptographic structure storing the one or more fingerprints associated with the one or more databases in the plurality of nodes.

6. The server of claim 1, wherein the at least one memory and the computer program code are configured to, with the at least one processor, cause the server to:
identify one or more nodes within the cryptographic structure associated with each of the determined one or more fingerprints; and
generate at least one verifying value associated with the one or more identified nodes, the at least one verifying value used to verify if the determined one or more fingerprints are part of the cryptographic structure.

7. The server of claim 6, wherein the cryptographic structure comprises a Merkle-Patricia Tree, and wherein the at least one memory and the computer program code are configured to, with the at least one processor, cause the server to:
identify one or more nodes within the cryptographic structure that forms a path from a top node to a base node, the top node associated with a first character and the base node associated with a last character of a fingerprint in the one or more fingerprints.

8. The server of claim 7, wherein the at least one memory and the computer program code are configured to, with the at least one processor, cause the server to:
generate verifying values of one or more sibling nodes of the one or more identified nodes within the cryptographic structure.

9. The server of claim 7 or 8, wherein the plurality of nodes in the Merkle-Patricia tree comprise one or more of a key/value pair or a branch node, wherein the key in the key/value pair is associated with a character of a corresponding fingerprint in the one or more fingerprints and the value in the key/value pair is associated with a location of the distributed ledger where the corresponding fingerprint is stored.

10. A method for processing a database query at a server, the server associated with one or more databases and a cryptographic structure, the cryptographic structure storing one or more fingerprints in a plurality of nodes, each of the one or more fingerprints associated with a respective database of the one or more databases, the method comprising:
receiving, at the server, an input requesting a database query result to the database query;
determining, at the server, the database query result based on the one or more databases in response to the input; and
determining, at the server, one or more fingerprints of the databases associated with the database query result, and a verifying value in response to the determined one or more fingerprints, the verifying value being one that is used to verify if the determined one or more fingerprints are part of the cryptographic structure.

11. The method of claim 10, further comprising:
constructing, at the server, the one or more databases based on information stored on a distributed ledger; and
generating, at the server, the one or more fingerprints, each of the one or more fingerprints associated with a respective database of the one or more databases.

12. The method of claim 11, wherein generating the one or more fingerprints comprises generating, at the server, each fingerprint based on a hash of the data stored on the respective database and a metadata value of the respective database.

13. The method of claim 11 or 12, further comprising transmitting the one or more fingerprints to a verification server, the verification server being configured to store the one or more fingerprints on the distributed ledger.

14. The method of claim 10, further comprising receiving, from a verification server, the cryptographic structure storing the one or more fingerprints associated with the one or more databases in the plurality of nodes.

15. The method of claim 10, wherein determining, at the server, the verifying value used to verify if the determined one or more fingerprints are part of the cryptographic structure comprises:
identifying, at the server, one or more nodes within the cryptographic structure associated with each of the determined one or more fingerprints; and
generating, at the server, at least one verifying value associated with the one or more identified nodes, the at least one verifying value used to verify if the determined one or more fingerprints are part of the cryptographic structure.

16. The method of claim 15, wherein the cryptographic structure comprises a Merkle-Patricia Tree, and wherein identifying the one or more nodes within the cryptographic structure associated with each of the determined one or more fingerprints comprises:
identifying, at the server, one or more nodes within the cryptographic structure that forms a path from a top node to a base node, the top node associated with a first character and the base node associated with a last character of a fingerprint in the one or more fingerprints.

17. The method of claim 16, wherein generating, at the server, at least one verifying value associated with the one or more identified nodes comprises:
generating verifying values of one or more sibling nodes of the one or more identified nodes within the cryptographic structure.

18. The method of claim 16 or 17, wherein the plurality of nodes in the Merkle-Patricia tree comprise one or more of a key/value pair or a branch node, wherein the key in the key/value pair is associated with a character of a corresponding fingerprint in the one or more fingerprints and the value in the key/value pair is associated with a location of the distributed ledger where the corresponding fingerprint is stored.
